(19) United States
(12) Patent Application Publication
(10) Pub. No.: US 2005/0258384 A1
(43) Pub. Date: Nov. 24, 2005

(54) Valve

(76) Inventor: Wilfried Leutner, Schwaebisch Gmuend (DE)

Correspondence Address: JORDAN AND HAMBURG LLP, 122 EAST 42ND STREET, SUITE 4000, NEW YORK, NY, 10168, US

(21) Appl. No.: 11/065,553

(22) Filed: Feb. 23, 2005

(30) Foreign Application Priority Data
Apr. 1, 2004 (DE) 102004015991.2

(51) Int. Cl. F16K 31/02

(52) U.S. Cl. 251/129.15

(57) ABSTRACT

A valve providing a controlled pressure for a hydraulic device includes a first control element and with a second control element, the first and second control elements being movable relative to one another under the influence of a nominal value input at a steering device and being brought into a neutral position with respect to one another by means of a restoring element, and a driving device with which the control elements can be moved relative to one another independently of the nominal value input at the steering device, in order to shift the hydraulic center of the valve. In order to create a valve with small overall dimensions and simple and reliable functions, provisions are made pursuant so that the driving device is constructed as an electrodynamic driving mechanism formed coaxially with the valve, and/or with an electrostatic stepper motor.

The invention relates to a valve, especially for providing a controlled pressure of a pressure medium for hydraulic power-assisted steering of the introductory portion of claim 1.

A hydraulic power-assisted steering system represents a meaningful possibility for supporting the steering power especially of commercial vehicles. Power-assisted hydraulic steering systems have a valve for the controlled metering of a pressure medium into working chambers of a servo valve of an actuator for actuating steered wheels of a vehicle. Servo valves may have control elements, which can be moved translationally or rotationally with respect to one another and be constructed, for example, as a rotary slide valve. In this connection, a first control element, constructed as a rotary valve, is twisted by a steering moment applied by steering handle relative to a second control element, which is constructed as a steering bushing. The rotary valve and the control bushing are connected over a torsion bar, which is disposed in an axial borehole of the control elements and attempts to hold the rotary valve and the control bushing in their middle position relative to one another. An output element, constructed, for example, as a pinion gear gear, is fixed at the control bushing and meshes with a gear rack, which may be connected as a transmission with the wheel steering levers of the steered wheels of the vehicle.

With such a valve, it is not possible to represent a variation of the characteristic line of the steering assistance as a function of vehicle and driving parameters or an autonomous function, which is supported by a driver, such as parking, or even autonomous driving.

DE 202 18 733 U1 describes a valve for a hydraulic power-assisted steering for providing a pressure medium at a controlled pressure with a first control element and with a second control element, the first and second control elements, under the influence of a nominal value input, being movable relative to one anoth er at a steering handle and being rotatable relative to one another to a limited extent from their middle position in the one or the other direction in order to produce steering assistance. Furthermore, the valve has a driving device, with which the steering characteristics can be influenced in different ways, in that the control elements can be moved relative to one another independently of the nominal value input at the steering handle.

The overall dimensions of the proposed valve are not minimized. Furthermore, the valve requires installation-intensive safety devices.

It is an object of the invention to provide a valve, especially for hydraulic power-assisted steering, the overall dimensions of which are small and the function of which is reliable.

This objective is accomplished with a valve having the distinguishing features of claim 1.

Owing to the fact that either the control elements of the valve are formed by an electrodynamic driving device, which is integrated coaxially with the valve and preferably in the configurational shape of the valve, or the driving device is formed from an electrostatic stepper motor of small overall dimensions using an expansion body of, perhaps, a silicon-containing material, the valve can be produced so that its overall dimensions are small and so that extensive safety measures or also cooling measures for the driving mechanism are not required.

Preferred embodiments arise out of the dependent claims.

The highest initial moments or pressure forces, in conjunction with the smallest step widths for the relative movement of the first and second control elements can be realized depending on the construction of the motor selected in the driving device. The driving device may be provided with an electrodynamic, rotating driving mechanism, which is constructed to be coaxial with the valve, or with an electrodynamic linear induction motor without permanent magnets, or with a DC motor or a linear induction motor, a position sensor or an angle of rotation sensor, which may also be part of a commutating device of the driving mechanism, measuring the relative movement and/or the relative position of the first and second control elements. The position of the control elements may also be supplied by optoelectrical means. The use of a preferably piezoelectric or magneto restrictive micro stepper motor represents one possibility of realizing a high regulating power for a driving device requiring the least possible overall dimensions and having a very fine step width. The configuration of the expansion elements of such micro stepper motors can be adapted to the overall dimensions of the valve. Sufficient correcting displacements of the first control element compared to the second control element of the valve can be realized with sheets of piezoelectric materials, which are connected in series and consist of ceramic materials based on rare earth or barium nitrate.

In principle, it is possible to select freely the mutual relationship between the displacement movement of the first control element relative to the second control element, induced by the nominal value input of the driver to the steering handle, to the displacement movement of the control elements, induced by the driving device. It is advisable to select the possible displacement path of the first control element relative to the second control element, produced by the driving device, to be smaller than the possible displacement path of the control elements by the nominal value input at the steering handle. Preferably, the pressure of the pressure medium, produced by the relative movement of the control elements from the driving device, is not more than about half the maximum pressure of the control medium, controlled by the valve. Accordingly, for the driver of the vehicle, there remains at least one adjustment possibility of the two control elements of the valve from the magnitude, that at least half the maximum pressure medium pressure can be triggered.

In a particularly preferred embodiment of the valve, the latter is constructed as a rotary valve. The first control element is constructed as a rotary valve and the second control element is constructed as a control bushing. The two elements are disposed so that they can rotate coaxially with one another. The rotary valve is connected in a known manner non-rotationally over a restoring element in the form of torsion bar with the steering handle and connected with the control bushing so that it can be rotated to a limited extent with respect to the latter. The control bushing is connected with an output element of the valve, the pinion gear, enabling an additional displacement path or rotation path to the control bushing, being rotatable to a limited extent with respect to the control bushing.

The pinion gear can be rotated relative to the control bushing by the driving device. The driving mechanism of the driving device is constructed as an electrodynamic driving mechanism with a stator and rotor disposed coaxially with the longitudinal axis of the valve. The rotor of the stepper motor is connected firmly with the control bushing and the stator is connected non-rotationally with the output element or the pinion gear. The driving mechanism may be constructed very small, since it does not lie in the flux of force between the torsion bar and the output element. It may also be appropriate to configure the torsion bar so that it can be rotated by the driving device relative to the rotary valve or to configure the pinion gear or the output element so that it can be rotated relative to the torsion bar.

The driving mechanism of the driving device need not necessarily be constructed as a directly driven stepper motor or micro stepper motor. Instead, any type of suitable reduction gear or cam mechanism, which can convert a movement direction of the driving mechanism into a different movement direction of the control elements, may be used. If a micro stepper motor is used, it may be appropriate to enlarge its correcting displacement by means of a step-up gear. Preferably, the driving device with a path sensor is accommodated and sealed in a housing of the valve. The driving device or also parts thereof may be connected firmly with the valve, as well as constructed to be movable with the valve or parts of the valve.

The valve is suitable particularly for representing different types of comfort functions also for commercial vehicles or heavy passenger vehicles.

The invention is now described in greater detail by means of an example and reproduced by means of the attached drawing, in which

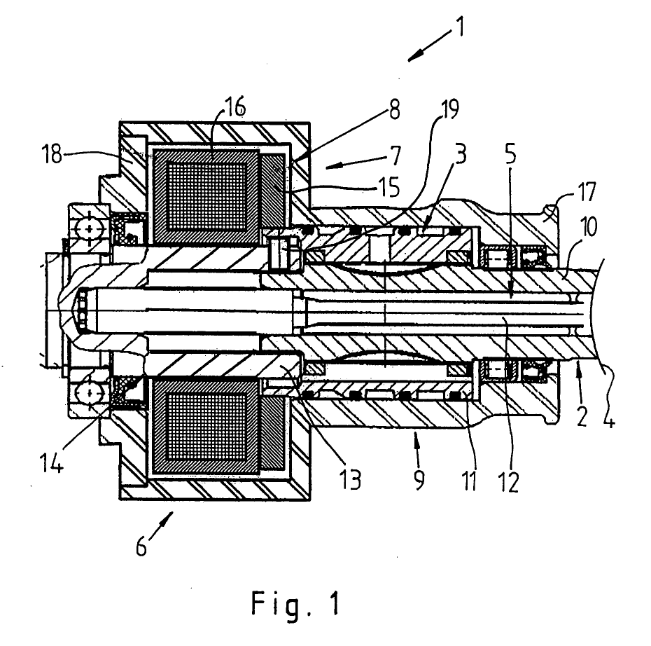

FIG. 1 shows a diagrammatic longitudinal section through an inventive valve.

FIG. 1 shows a diagrammatic longitudinal section of a valve 1 for a hydraulic power-assisted steering of a commercial vehicle, which has a stepped wheel cylinder-type of housing 17 with a lid 18 disposed at one axial end of the valve 1. The valve 1 is constructed as a rotary slide valve 9 and connected with a pressure medium container, which is not shown, and a hydraulic pump. The pressure medium container has a fluid connection with a low pressure connection and the hydraulic pump has a fluid connection with a high-pressure connection of the rotary slide valve 9. The rotary slide valve 9 controls the pressure medium as a function of a nominal value input at the steering handle 4 of the commercial vehicle in working spaces of a hydraulic actuator (not shown) for adjusting the steering angle of steered wheels of the commercial vehicle.

In the housing 17 of the rotary slide valve 9, a cylindrical rotary valve 10, which forms a first control element 2 of the valve 1, in a control bushing 11, which forms a second control element 3 of the valve 1, is mounted so that it can rotate. The rotary valve 10 is connected over a restoring element 5, constructed as a torsion bar 12, with the control bushing 11. The control bushing 11 is connected non-rotationally with an output element 14, which is constructed as a pinion gear 13, the pinion gear 13 meshing with a gear rack, which is not shown. When a steering moment is applied on the steering handle 4, initially the torsion bar 12 twists and the control bushing 11 is twisted relative to the rotary slide 10, as a result of which the flow of pressure medium is controlled by the valve 1 and the steering moment is supported by the hydraulic actuator.

Within a region, defined by pins 19, which protrude radially out of the control bushing 11 in slot-shaped recesses of the pinion gear 13 extending in the peripheral direction, the pinion gear 13 can be rotated to a limited extent relative to the control bushing 11. When the driving device 6 is not activated, the restoring device may also be used to bring the pinion gear 13 into a neutral or middle position relative to the control bushing 11. The restoring device can also be constructed itself by piezoelectric or magneto restrictive micro stepper motors between the control bushing 11 and the rotary slide 10 or between components of the valve 1, connected with the rotary valve 10 and the control bushing 1, in that these are not supplied with electric power.

The rotary slide valve 9 has an open center, that is, all connections, such as the low-pressure connection, the high-pressure connection and the pressure medium pipelines to the working spaces of the hydraulic actuator, communicate with one another, when the rotary valve 10 assumes a middle position to the control bushing 11.

In order to make it possible to operate the valve 1 so as to influence the steering moment at the steering handle 4 and the nominal value input of the driver at the steering handle 4 in a defined manner, in order to provide, for instance, an automatic steering function or stabilizing functions for the driving, the hydraulic center of the valve 1 is adjustable. In this connection, a driving device 6, which is constructed in the example shown of a rotating driving mechanism 8, which preferably is as an electrodynamic stepper motor, takes over the relative twisting of the control bushing 11 to the pinion gear 13 and, with that, to the rotary valve 10 independently of the steering moment input of the driver. Moreover, the pinion gear 13 can be rotated in the manner described between stops relative to the control bushing 11. For this purpose, a stator 16 of the drive motor 7 is connected with the pinion gear 13 and a rotor 15 is connected with the control bushing 11. In order to be able to construct the driving mechanism of the driving device 6 even smaller, piezoelectric or magneto restrictive or other suitable micro stepper motors can be disposed directly in the valve housing between the first and the second control elements 2, 3.

### LIST OF REFERENCE NUMBERS

1 valve
2 first control element
3 second control element
4 steering handle
5 resting element
6 driving device
7 driving mechanism, electrodynamic, electric stepper motor
8 driving mechanism, rotating1
9 rotary slide valve
10 rotary valve
11 control bushing
12 torsion bar
13 pinion gear
14 output element
15 rotor
16 stator
17 housing
18 lid
19 pin

1. A valve comprising a first control element and a second control element, the first and second control elements being movable relative to one another under the influence of a nominal value input to a steering device and being brought into a neutral position with respect to one another by means of a restoring element, a driving device with which the control elements can be moved relative to one another independently of the nominal value input at the steering device, said driving device having an electrodynamic driving mechanism and/or an electrostatic stepper motor formed coaxially with the valve.

2. The valve of claim 1, wherein the driving device comprises an electrodynamic, rotating driving mechanism.

3. The valve of claim 1, wherein the driving device comprising an electrodynamic linear motor, a DC linear motor or a linear induction motor.

4. The valve of one of claim 1, wherein the driving device comprising an electrodynamic stepper motor.

5. The valve of claim 1, wherein the driving device comprises a piezoelectric or magneto restrictive micro stepper motor.

6. The valve of claim 1, wherein the first control element and the second control element are rotated relative to one another and/or moved translationally by the driving device.

7. The valve of claim 1, wherein the displacement path of the first control element relative to the second control element, by the driving device, is smaller than the possible displacement path of the control elements by the nominal value input at the steering device.

8. The valve of claim 1, wherein the displacement path of the control elements is limited by the driving device so that at least half the maximum pressure of the medium pressure can still be selected by the nominal value input at the steering device.

9. The valve of claim 1, wherein the valve is constructed as a rotary slide valve and the first control element as a rotary valve and the second control element as a control bushing which are constructed so that they can rotate relative to one another, the rotary slide being connected non-rotationally by the restoring element, constructed as a torsion bar, with the steering device and the control bushing being connected with a driving element of the valve, constructed as a pinion gear, enabling rotation of the control bushing to a limited extent with respect to the drive element by the driving device.

10. The valve of claim 9, wherein a rotor or a stator of the driving device is firmly connected with the control bushing and a stator or a rotor of the driving device is connected firmly with the driving element or pinion gear.

11. The valve of claim 1, wherein the valve is constructed as a rotary slide valve and the first control element, as a rotary slide, and the second control element, as a control bushing, which are constructed so that they can be rotated relative to one another, the rotary valve being connected over the restoring element, constructed as a torsion bar, with the steering device and the driving device being able to twist the torsion bar relative to the rotary slide.

12. The valve of claim 1, wherein the valve is constructed as a rotary slide valve and the first control element as a rotary valve, and the second control element, as a control bushing which are constructed so that they can be rotated relative to one another, the rotary valves being connected over the restoring element constructed as a torsion bar and the control bushing being connected rotatably with the driving element constructed as a pinion gear and the driving device being able to rotate the pinion gear relative to the torsion bar.

13. The valve of claim 1, wherein the driving device comprises a transmission.

14. The valve of claim 1, wherein the driving device is constructed as a direct driving mechanism for the control elements.

15. The valve of claim 1, wherein the driving device is attached to the housing with the valve.

16. The valve of that claim 1, wherein the driving device can be moved with parts of the valve.

17. The valve of claim 1, wherein the valve is part of a hydraulic power-assisted steering of a vehicle.

18. The valve of claim 1, wherein the valve provides a controlled pressure for a pressure medium for hydraulic power assisted steering.
